(19) United States
(12) Patent Application Publication
(10) Pub. No.: US 2018/0181911 A1
(43) Pub. Date: Jun. 28, 2018

(54) DATA OBJECT ALLOCATION METHOD AND APPARATUS AND ELECTRONIC DEVICE

(71) Applicant: Beijing Xiaodu Information Technology Co., Ltd., Beijing (CN)

(72) Inventors: Lang Liu, Beijing (CN); Dairui Cui, Beijing (CN); Mingquan Xu, Beijing (CN); Shaojian Huang, Beijing (CN); Ke Xian, Beijing (CN); Congyu Wang, Beijing (CN); Daohong Jian, Beijing (CN); Bin Zhang, Beijing (CN)

(21) Appl. No.: 15/902,236

(22) Filed: Feb. 22, 2018

Related U.S. Application Data
(63) Continuation of application No. PCT/CN2017/094785, filed on Jul. 27, 2017.

(30) Foreign Application Priority Data
Nov. 23, 2016 (CN) 201611042633.4

(51) Int. Cl. G06Q 10/08; G06Q 50/28; G06F 17/50

(52) U.S. Cl. CPC G06Q 10/0834; G06F 17/5009; G06Q 50/28

(57) ABSTRACT

Embodiments of the present invention provide a data object allocation method and apparatus and an electronic device. The method includes:
pre-allocating a to-be-allocated data object to a first terminal, where the to-be-allocated data object is grouped into a data object group; simulating processing of the data object group by the first terminal and a second terminal associated with the data object group; and allocating the to-be-allocated data object to the first terminal if two simulation results meet a preset condition. According to the embodiments of the present invention, data object allocation efficiency is enhanced, and overall processing effect is optimized.

### CROSS REFERENCE

This application is a continuation of International Patent Application No. PCT/CN2017/094785, filed on Jul. 27, 2017 and entitled “DATA OBJECT ALLOCATION METHOD AND APPARATUS AND ELECTRONIC DEVICE”, which claims priority to Chinese Patent Application No. 201611042633.4, filed on Nov. 23, 2016 and entitled “DATA OBJECT ALLOCATION METHOD AND APPARATUS AND ELECTRONIC DEVICE”, all of which are incorporated herein by reference in its entirety.

### TECHNICAL FIELD

Embodiments of the present invention relate to the field of Internet technologies, and in particular, to a data object allocation method and apparatus and an electronic device.

### BACKGROUND

With the rapid development of Internet technologies, there are increasing numbers of Internet-based applications, such as take-out applications and shopping applications. Using these applications, a user can obtain the needed products without leaving his/her home. While they are convenient to users, these applications need to deal with the issue of product delivery. Thus, logistics dispatch systems have emerged accordingly. The main task of a logistics system is to allocate a new order to a suitable delivery person.

In related technologies, an order allocation process is as follows: After a new order is generated, the logistics dispatch system searches for delivery persons near the store where the new order is generated, and sends information about such delivery persons to a logistics dispatcher; the logistics dispatcher manually determines a suitable delivery person according to information such as current locations of the delivery persons and the number of existing orders, and allocates the new order to a suitable delivery person using the logistics dispatch system.

### SUMMARY

In practical application, the inventor finds that in related technologies, order allocation needs to be processed manually, resulting in low efficiency in order allocation, especially when a large number of new orders are generated in a short period. In such instances, there is very low efficiency in order allocation, and it is very hard to optimize order allocation; as a result, some orders cannot be delivered on time, and sometimes the delays could be lengthy.

To solve the foregoing technical problems, the embodiments of the present invention provide a data object allocation method, including:

pre-allocating a to-be-allocated data object to a first terminal, where the to-be-allocated data object is grouped into a data object group;

simulating processing of the data object group by the first terminal and a second terminal associated with the data object group; and

allocating the to-be-allocated data object to the first terminal if two simulation results meet a preset condition.

In an optional implementation, pre-allocating the to-be-allocated data object to the first terminal includes:

determining a matching degree between each terminal in a first terminal group and the to-be-allocated data object; and

selecting the first terminal from the first terminal group according to the matching degree between each terminal in the first terminal group and the to-be-allocated data object.

In an optional implementation, determining a matching degree between each terminal in a first terminal group and the to-be-allocated data object includes:

calculating a similarity index between an existing data object of the first terminal and the to-be-allocated data object; and

obtaining the matching degree according to the similarity index between the existing data object and the to-be-allocated data object.

In an optional implementation, the method further includes:

grouping data objects pre-allocated to the first terminal to obtain the data object group; where the data objects pre-allocated to the first terminal include the to-be-allocated data object.

In an optional implementation, grouping data objects pre-allocated to the first terminal includes:

grouping the data objects pre-allocated to the first terminal according to a similarity index between the data objects pre-allocated to the first terminal to obtain the data object group.

In an optional implementation, the method further includes: selecting the second terminal from a second terminal group, where the second terminal group includes at least one terminal to which no data object is pre-allocated.

In an optional implementation, selecting the second terminal from a second terminal group includes:

determining a group matching degree between each terminal in the second terminal group and the data object group; and

selecting the second terminal from the second terminal group according to the group matching degree between each terminal in the second terminal group and the data object group.

In an optional implementation, determining a group matching degree between each terminal in the second terminal group and the data object group includes:

determining a matching degree between each data object in the data object group and the second terminal; and

obtaining the group matching degree according to the matching degree between each data object and the second terminal.

In an optional implementation, the to-be-allocated data object is a to-be-allocated order, the data object group is an order group, the processing is delivery, the first terminal is a terminal of a pre-allocated delivery person, and the second terminal is a terminal of a reference delivery person.

In an optional implementation, simulating processing of the data object group by the first terminal and a second terminal associated with the data object group includes:

forming a list of to-be-delivered orders according to the order group and an undelivered order of a simulation object, where the simulation object is the pre-allocated delivery person or the reference delivery person;

designing a delivery route of the simulation object according to a selected route designing algorithm according to attribute information of orders in the list of to-be-delivered orders; and

estimating, according to an average speed and the delivery route of the simulation object, indicator data to be generated when the orders in the list of to-be-delivered orders are actually delivered, and using the indicator data as delivery indicator data of the simulation object.

In an optional implementation, allocating the to-be-allocated data object to the first terminal if two simulation results meet a preset condition includes:

calculating respective evaluation scores of the pre-allocated delivery person and the reference delivery person according to respective delivery indicator data of the pre-allocated delivery person and the reference delivery person; and

if the evaluation score of the pre-allocated delivery person is higher than the evaluation score of the reference delivery person, allocating the to-be-allocated order to the pre-allocated delivery person.

Correspondingly, the embodiments of the present invention further provide a data object allocation apparatus, including:

a pre-allocation unit, configured to pre-allocate a to-be-allocated data object to a first terminal, where the to-be-allocated data object is grouped into a data object group;

a simulation unit, configured to simulate processing of the data object group by the first terminal and a second terminal associated with the data object group; and

an allocation unit, configured to allocate the to-be-allocated data object to the first terminal if two simulation results meet a preset condition.

In an optional implementation, the pre-allocation unit is configured to: determine a matching degree between each terminal in a first terminal group and the to-be-allocated data object; and select the first terminal from the first terminal group according to the matching degree between each terminal in the first terminal group and the to-be-allocated data object.

In an optional implementation, the apparatus further includes a grouping unit, configured to group data objects pre-allocated to the first terminal to obtain the data object group, where the data objects pre-allocated to the first terminal include the to-be-allocated data object.

In an optional implementation, the apparatus further includes a selection unit, configured to select the second terminal from a second terminal group, where the second terminal group includes at least one terminal to which no data object is pre-allocated.

In an optional implementation, the selection unit is configured to: determine a group matching degree between each terminal in the second terminal group and the data object group; and select the second terminal from the second terminal group according to the group matching degree between each terminal in the second terminal group and the data object group.

In an optional implementation, the to-be-allocated data object is a to-be-allocated order, the data object group is an order group, the processing is delivery, the first terminal is a terminal of a pre-allocated delivery person, and the second terminal is a terminal of a reference delivery person.

In an optional implementation, the simulation unit is configured to: form a list of to-be-delivered orders according to the order group and an undelivered order of a simulation object, where the simulation object is the pre-allocated delivery person or the reference delivery person; design a delivery route of the simulation object according to a selected route designing algorithm according to attribute information of orders in the list of to-be-delivered orders; and estimate, according to an average speed and the delivery route of the simulation object, indicator data to be generated when the orders in the list of to-be-delivered orders are actually delivered, and use the indicator data as delivery indicator data of the simulation object.

In an optional implementation, the allocation is configured to: calculate respective evaluation scores of the pre-allocated delivery person and the reference delivery person according to respective delivery indicator data of the pre-allocated delivery person and the reference delivery person; and if the evaluation score of the pre-allocated delivery person is higher than the evaluation score of the reference delivery person, allocate the to-be-allocated order to the pre-allocated delivery person.

The embodiments of the present invention further provide an electronic device, including a memory and a processor, where

the memory is configured to store one or more computer instructions, where the one or more computer instructions are executed by the processor to implement:

pre-allocating a to-be-allocated data object to a first terminal, where the to-be-allocated data object is grouped into a data object group;

simulating processing of the data object group by the first terminal and a second terminal associated with the data object group; and

allocating the to-be-allocated data object to the first terminal if two simulation results meet a preset condition.

The embodiments of the present invention further provide a computer readable storage medium, storing a computer instruction, where the following steps are implemented when the computer instruction is executed by a processor:

pre-allocating a to-be-allocated data object to a first terminal, where the to-be-allocated data object is grouped into a data object group;

simulating processing of the data object group by the first terminal and a second terminal associated with the data object group; and

allocating the to-be-allocated data object to the first terminal if two simulation results meet a preset condition.

In the embodiments of the present invention, the to-be-allocated data object is not directly allocated to the first terminal, but is pre-allocated to the first terminal, and the to-be-allocated data object is grouped into a data object group, processing of the data object group including the to-be-allocated data object by the second terminal and the first terminal is simulated, and when the two simulation results meet the preset condition, the to-be-allocated data object is allocated to the first terminal. The pre-allocation process and the simulation process are combined, so that automatic data object allocation is implemented, and the allocation method with a better processing effect is selected. Therefore, allocation efficiency is enhanced, and the overall processing effect is optimized.

### BRIEF DESCRIPTION OF DRAWINGS

Accompanying drawings of the specification constructs a part of the present invention and are provided for further understanding of the present invention. Exemplary embodiments and descriptions thereof in the present invention are used to explain the present invention and do not constitute limitation on the present invention. In the drawings:

FIG. 1 is a schematic flowchart of a data object allocation method according to an exemplary embodiment of the present invention;

FIG. 2 is a schematic flowchart of an order allocation method according to another exemplary embodiment of the present invention;

FIG. 3 is a schematic flowchart of simulating order group delivery according to another exemplary embodiment of the present invention;

FIG. 4 is a schematic structural diagram of a data object allocation apparatus according to still another exemplary embodiment of the present invention; and

FIG. 5 is a schematic structural diagram of a data object allocation apparatus according to still another exemplary embodiment of the present invention.

### DESCRIPTION OF EMBODIMENTS

To make the objectives, technical solutions, and advantages of the present invention clearer, the technical solutions of the present invention are described below with reference to specific embodiments of the present invention and corresponding accompanying drawings. Apparently, the described embodiments are a part rather than all of the embodiments of the present invention. All other embodiments obtained by a person of ordinary skill in the art based on the embodiments of the present invention without creative efforts shall fall within the protection scope of the present invention.

As mentioned above, in practical application, the inventor finds that in related technologies, order allocation needs to be processed manually, and consequently the order allocation efficiency is relatively low; especially when a large number of new orders are generated in a short period. In such instances, there is very low efficiency in order allocation, and it is very hard to optimize order allocation; as a result, some orders cannot be delivered on time, and sometimes the delays could be lengthy.

For the foregoing technical problems, the inventor of the present invention comes up with the idea that if automatic order allocation is implemented to free up labor from the order allocation process, order allocation efficiency will be greatly improved. While it is not difficult to come up with the idea of automatic order allocation, the difficulty lies in what technical means can be used to implement automatic order allocation to ensure both order allocation efficiency and overall order delivery efficiency.

Order allocation is the prerequisite of order delivery. Automatic order allocation can ensure order allocation efficiency, but may not ensure overall order delivery efficiency. The following examples are used to illustrate this.

A technical means for implementing automatic order allocation may be as follows: When a new order is received, delivery persons near the store in which the new order is located are obtained, a delivery person is randomly selected, and the new order is allocated to the randomly-selected delivery person. This order allocation method involves no labor, and allocation efficiency is extremely high. However, after a test run, it is found that when the randomly-selected delivery person already has a relatively large number of orders, if orders are delivered in the order allocation sequence, the new order probably cannot be delivered on time; if orders are delivered according to order priorities, and if the new order has a high priority and can be preferably delivered, delivery of the existing orders is delayed, and the efficiency of delivering the existing orders is adversely impacted.

Another technical means for implementing automatic order allocation may be as follows: When a new order is received, delivery persons near the store in which the new order is located are obtained, a delivery person having the minimum number of existing orders is selected according to number of existing orders of the delivery persons, and the new order is allocated to the delivery person having the minimum number of existing orders. This order allocation method involves no labor either, allocation efficiency is relatively high, and the problem existed in the first technical means can be solved. However, after a test run, it is found that if the delivery person having the minimum number of existing orders is far from the store in which the new order is located, regardless of whether orders are delivered in the order allocation sequence or according to order priorities, extra traveling distance is added for the delivery person (i.e., more distance is traveled), and overall delivery efficiency is reduced.

It can be learned from the foregoing examples that while it is not difficult to simply implement automatic order allocation, it is a real challenge to implement automatic order allocation to ensure both allocation efficiency and overall delivery efficiency so as to reduce delivery costs.

In view of the foregoing problems, the inventor of the present invention finds, after numerous studies and practical experiences, that order allocation is complex and volatile. Therefore, rather than providing one technical solution that can solve all order allocation problems, the inventor comes up with the idea of combining two or more allocation solutions to solve the order allocation problems. Therefore, the inventor of the present invention puts forward a large number of allocation solutions, selects preferred allocation solutions from the large number of allocation solutions after tests or trials, and selects the most suitable allocation solution from the preferred allocation solutions for new orders, so that allocation efficiency and overall delivery efficiency are both optimized.

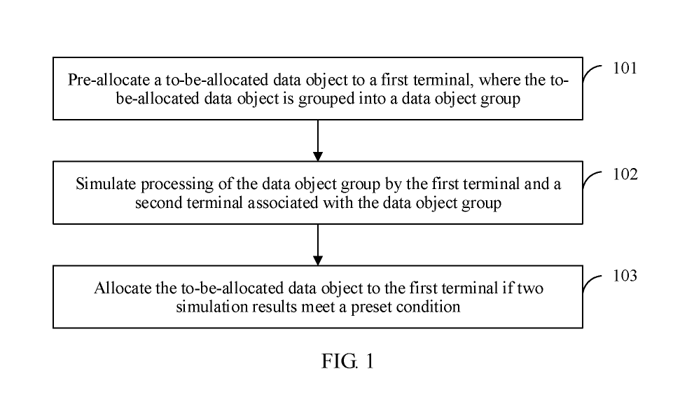

The embodiments of the present invention provide a data object allocation method. FIG. 1 is a schematic flowchart of a data object allocation method according to an exemplary embodiment of the present invention. As shown in FIG. 1, the method includes:

101. Pre-allocate a to-be-allocated data object to a first terminal, where the to-be-allocated data object is grouped into a data object group.

102. Simulate processing of the data object group by the first terminal and a second terminal associated with the data object group.

103. Allocate the to-be-allocated data object to the first terminal if two simulation results meet a preset condition.

In this embodiment, network data that needs to be allocated to a terminal for processing is referred to as a to-be-allocated data object, and the to-be-allocated data object may be any network data, such as an order.

For different to-be-allocated data objects, the processing of the to-be-allocated data objects is different, and terminals responsible for processing the to-be-allocated data objects are also different. If the to-be-allocated data object is an order, processing of the order is mainly order delivery, and correspondingly the terminal may be the terminal of a delivery person.

In this embodiment, the data objects can be allocated using a parallel method. The parallel allocation method is a method of independently allocating a single data object to a terminal, and has relatively high efficiency. In this embodiment, the parallel allocation method is used, but it is not directly used to perform data object allocation; instead, the parallel allocation method is compared with another allocation method using pre-allocation and simulation of the allocation effects to determine whether to use the parallel allocation method. In this embodiment, the other allocation method is mostly the allocation method of grouping data objects and allocating the data object to a terminal based on data object group, but is not limited to this method.

When a to-be-allocated data object is generated, the to-be-allocated data object is not directly allocated to the first terminal using the parallel allocation method, but is pre-allocated to the first terminal, the processing result after the to-be-allocated data object is allocated using the parallel allocation method and the processing result after the to-be-allocated data object is allocated using the grouping allocation method are compared, and based on the comparison result, whether to use the parallel allocation method to allocate the to-be-allocated data object to the first terminal is determined so as to take into consideration both the allocation efficiency and the subsequent processing effect.

To facilitate comparison between the processing result after the to-be-allocated data object is allocated using the parallel allocation method and the processing result after the to-be-allocated data object is allocated using the grouping allocation method, in addition to pre-allocating the to-be-allocated data object to the first terminal, the to-be-allocated data object needs to be grouped into the data object group, and another terminal, also referred to as the second terminal, associated with the data object group needs to be determined. The to-be-allocated data object is allocated to the second terminal using the grouping allocation method. The second terminal is different from the first terminal.

The data object group includes the to-be-allocated data object; therefore, processing of the data object group by the first terminal and the second terminal may be separately simulated to obtain the two simulation results. A simulation result obtained by simulating processing of the data object group by the first terminal is equivalent to the processing result after the to-be-allocated data object is allocated using the parallel allocation method; correspondingly, a simulation result obtained by simulating processing of the data object group by the second terminal is equivalent to the processing result after the to-be-allocated data object is allocated using the grouping allocation method. For different to-be-allocated data objects, processing methods used after the to-be-allocated data objects are allocated are different. For example, if the to-be-allocated data object is an order, processing after order allocation is mainly the process of delivering orders in an order group to which the order belongs. The two simulation results are compared, and if the two simulation results meet a preset condition, it indicates that allocating the to-be-allocated data object to the first terminal using the parallel allocation method not only ensure allocation efficiency but also the processing effect. Therefore, the parallel allocation method is selected, and the to-be-allocated data object is independently allocated to the first terminal.

It should be noted that the foregoing preset condition may be different in different application scenarios. This will be described by using examples in a subsequent embodiment including an application scenario.

Optionally, if the two simulation results do not meet the preset condition, it indicates that allocating the to-be-allocated data object to the first terminal using the parallel allocation method does not ensure both allocation efficiency and the processing effect. Therefore, the grouping allocation method is selected to allocate the to-be-allocated data object.

It can be learned from the foregoing that, in this embodiment, the parallel allocation method is used, but it is not directly used to perform data object allocation; instead, the parallel allocation method is compared with the grouping allocation method using pre-allocation and simulation of the allocation effects to determine whether to use the parallel allocation method; when the two simulation results meet the preset condition, the parallel allocation method is used, and the to-be-allocated data object is independently allocated to the first terminal. This not only ensures high allocation efficiency but also good overall processing effect.

In the foregoing embodiment and the subsequent embodiment, there are multiple terminals that can process data objects. Preliminary screening may be performed on the multiple terminals according to a specific policy or criterion to obtain a first terminal group. The first terminal group includes at least one terminal. For example, terminals located near the to-be-allocated data object may be selected to form the first terminal group, but are not limited to such terminals. In another example, terminals with abundant resources may be selected to form the first terminal group. In another example, terminals that are located near the to-be-allocated data object and have abundant resources may be selected to form the first terminal group.

On the basis of the first terminal group, the step of pre-allocating a to-be-allocated data object to a first terminal includes: selecting the first terminal from the first terminal group, and pre-allocating the to-be-allocated data object to the first terminal, obtaining the first terminal group from the multiple terminals by means of screening, and selecting the first terminal from the first terminal group helps to improve selection efficiency and save resources. Optionally, a selecting step of the first terminal includes: determining a matching degree between each terminal in the first terminal group and the to-be-allocated data object; and selecting the first terminal from the first terminal group according to the matching degree between each terminal in the first terminal group and the to-be-allocated data object. In different application scenarios, the first terminal is selected based on the matching degree in different methods. For example, a terminal may be selected as the first terminal when a matching degree between the terminal and the to-be-allocated data object is the highest. In another example, a terminal may be selected as the first terminal when a matching degree between the terminal and the to-be-allocated data object falls within a specified range.

The first terminal in the first terminal group is used as an example to describe the step of determining a matching degree between a terminal and the to-be-allocated data object. For this step, an optional method includes: calculating a similarity index between an existing data object of the first terminal and the to-be-allocated data object, and obtaining a matching degree between the first terminal and the to-be-allocated data object according to the similarity index between the existing data object and the to-be-allocated data object. The existing data object of the first terminal is a data object that has been allocated to the first terminal. The method of allocating the existing data object is not limited. The existing data object may be allocated to the first terminal using the parallel allocation method, or may be allocated to the first terminal using the grouping allocation method.

Optionally, the similarity index between the existing data object of the first terminal and the to-be-allocated data object may be calculated according to an attribute of the existing data object and an attribute of the to-be-allocated data object. For example, if the existing data object and the to-be-allocated data object are orders, the attribute includes but is not limited to a store attribute, a user attribute, a time attribute, a location attribute, and the like that are related to the order.

It should be noted that the first terminal may have at least one existing data object, a similarity index between the at least one existing data object of the first terminal and the to-be-allocated data object may be calculated, and the matching degree between the first terminal and the to-be-allocated data object is obtained according to the similarity index between the at least one existing data object and the to-be-allocated data object. For example, the highest similarity index may be selected from the similarity index between the at least one existing data object and the to-be-allocated data object as the matching degree between the first terminal and the to-be-allocated data object. In another example, an average value of the similarity index between the at least one existing data object and the to-be-allocated data object may be calculated, and the average value is used as the matching degree between the first terminal and the to-be-allocated data object. In another example, a similarity index within a specified range may be selected from the similarity index between the at least one existing data object and the to-be-allocated data object, and an average value of the selected similarity index within the specified range may be calculated and used as the matching degree between the first terminal and the to-be-allocated data object.

In the foregoing implementation, the first terminal in the first terminal group is used as an example to describe the step of determining a matching degree between a terminal and the to-be-allocated data object, and for a second terminal, a third terminal, or another terminal in the first terminal group, the same method may be used to calculate a matching degree between the terminal and the to-be-allocated data object.

In the foregoing embodiment or the following embodiment, the to-be-allocated data object is grouped into a data object group. The data object group includes the to-be-allocated data object, and other data objects other than the to-be-allocated data object are not limited. Optionally, the to-be-allocated data object may be grouped into a data object group according to a similarity index between data objects.

In one scenario, the to-be-allocated data object may be grouped into an existing data object group. A similarity index between the to-be-allocated data object and a data object included in at least one existing data object group may be calculated, a similarity index between the to-be-allocated data object and the at least one existing data object group is calculated according to the similarity index between the to-be-allocated data object and the data object included in the at least one existing data object group, and the to-be-allocated data object is grouped into the data object group where the similarity index between the to-be-allocated data object and the data object group is the highest.

In another scenario, the to-be-allocated data object may be grouped into a new data object group. Similarities between candidate data objects and the to-be-allocated data object may be calculated; a data object is selected from the candidate data objects where a similarity index between the data object and the to-be-allocated data object is greater than a threshold; and the selected data object and the to-be-allocated data object are grouped into a data object group.

Optionally, if the simulation result obtained by simulating processing, by the first terminal, of the data object group including the to-be-allocated data object is ideal, for example, better than the simulation result obtained by simulating processing of the data object group by the second terminal, the to-be-allocated data object is allocated to the first terminal. Based on this, the to-be-allocated data object may be grouped into a data object group in the first terminal. In this way, processing effects after the to-be-allocated data object is allocated using the two allocation methods may be compared, and the real processing effect after the to-be-allocated data object is allocated to the first terminal can be obtained in advance, and it can be learned whether efficiency of processing another data object by the first terminal is affected after the to-be-allocated data object is allocated to the first terminal. This helps to determine more accurately whether to use the parallel allocation method to independently allocate the to-be-allocated data object to the first terminal.

For example, the to-be-allocated data object may be grouped into an existing data object group in the first terminal, or the to-be-allocated data object may be grouped into a new data object group in the first terminal.

In application, data objects may be periodically allocated. When an allocation period ends, allocation processing may be separately performed, by using the method in this embodiment of the present invention, on data objects collected in the period. In this application, multiple data objects may be pre-allocated to one terminal. To make comparison with the grouping allocation method, the multiple data objects pre-allocated to the terminal may be grouped, to obtain a new data object group. Based on this, the method of grouping the to-be-allocated data object into the data object group includes: grouping data objects pre-allocated to the first terminal to obtain a data object group including the to-be-allocated data object. The data objects pre-allocated to the first terminal include the to-be-allocated data object. In addition, the data objects pre-allocated to the first terminal are grouped, so that at least one data object group can be obtained, where a data object group includes the to-be-allocated data object.

Optionally, the step of grouping data objects pre-allocated to the first terminal includes: grouping the pre-allocated data objects according to a similarity index between the data objects pre-allocated to the first terminal. In this way, similar data objects are grouped into a same data object group. Optionally, a similarity index between data objects may be calculated according to attributes of the data objects. For example, data objects that are close to each other may be grouped into a same data object group according to location attributes of the data objects; or data objects generated within a same time period may be grouped into a same data object group according to time attributes of the data objects.

In the foregoing embodiment or the following embodiment, to simulate the grouping allocation method, the second terminal associated with the data object group including the to-be-allocated data object needs to be determined. It should be noted that there may be one or more second terminals. Optionally, there are multiple second terminals.

Optionally, the second terminal may be selected from a second terminal group. The second terminal group includes at least one terminal to which no data object is pre-allocated.

Optionally, the step of selecting the second terminal includes: determining a group matching degree between each terminal in the second terminal group and the data object group including the to-be-allocated data object; and selecting the second terminal from the second terminal group according to the group matching degree between each terminal in the second terminal group and the data object group. For example, a terminal may be selected as the second terminal, where a group matching degree between the terminal and the data object group is the highest. In another example, a terminal may be selected as the second terminal, where a group matching degree between the terminal and the data object group falls within a specified range.

Optionally, the second terminal in the second terminal group is used as an example to describe the step of determining a group matching degree between a terminal and the data object group. Optionally, the step of determining a group matching degree includes: determining a matching degree between each data object in the data object group and the second terminal; and obtaining a group matching degree between the data object group and the second terminal according to the matching degree between each data object in the data object group and the second terminal. For example, a maximum matching degree may be selected from the matching degrees between all the data objects in the data object group and the second terminal as the group matching degree between the data object group and the second terminal. In another example, an average value of the matching degrees between all the data objects in the data object group and the second terminal may be calculated and used as the group matching degree between the data object group and the second terminal. In another example, matching degrees within a specified range may be selected from the matching degrees between all the data objects in the data object group and the second terminal, and an average value of the matching degrees within the specified range may be calculated and used as the group matching degree between the data object group and the second terminal,

Optionally, a first data object in the data object group is used as an example to describe the step of determining a matching degree between a data object and the second terminal. For example, the step of determining a matching degree between a data object and the second terminal includes: determining a similarity index between an existing data object of the second terminal and the first data object, and calculating a matching degree between the first data object and the second terminal according to the similarity index between the existing data object of the second terminal and the first data object. Optionally, the similarity index between the existing data object and the first data object may be calculated according to an attribute of the existing data object and an attribute of the first data object.

In the foregoing implementation, the first data object is used as an example to describe the step of determining a matching degree between a data object and the second terminal, and for a second data object, a third data object, or another data object in the data object group, the same method may be used to calculate a matching degree between the data object and the second terminal.

In the foregoing implementation, the second terminal is used as an example to describe the step of determining a group matching degree between a terminal and the data object group, and for a first terminal, a third terminal, or another terminal in the second terminal group, the same method may be used to calculate a group matching degree between the terminal and the data object group.

Optionally, in an application, based on the first terminal group, the second terminal group may be derived from the first terminal group. For example, at least one terminal to which no data object is pre-allocated is obtained from the first terminal group to form the second terminal group.

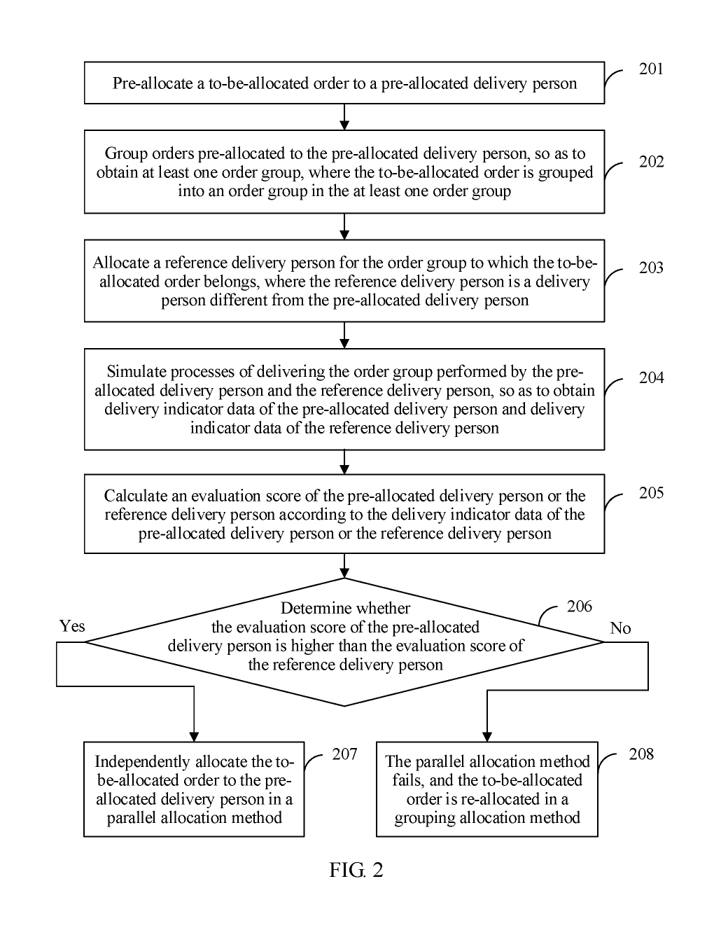

In a logistics dispatch system, the foregoing to-be-allocated data object may be a to-be-allocated order. In view of this, an embodiment of the present invention provides an order allocation method. As shown in FIG. 2, the method includes the following steps:

Refer to step 201: Pre-allocate the to-be-allocated order to a pre-allocated delivery person.

In this embodiment, before the parallel allocation method is used, the to-be-allocated order is pre-allocated to a delivery person, which is referred to as a pre-allocated delivery person.

In a specific implementation, pre-allocating/allocating the to-be-allocated order to the delivery person is actually pre-sending/sending the to-be-allocated order to a terminal of the delivery person. Therefore, the terminal of the pre-allocated delivery person is equivalent to the foregoing first terminal.

Optionally, preliminary screening may be performed on delivery persons to obtain a first delivery person set, and the first delivery person set includes at least one delivery person. For example, a delivery person that is relatively close to the to-be-allocated order (a distance from the delivery person to the to-be-allocated order is less than a threshold) may be selected according to current locations of delivery persons and a location of the to-be-allocated order, to form the first delivery person set. In another example, a delivery person having a small number of existing orders may be selected according to number of existing orders of the delivery persons, to form the first delivery person set.

Optionally, for any delivery person in the first delivery person set, the delivery person may have multiple orders, similarities between the existing orders of the delivery person and the to-be-allocated order may be separately calculated, and the highest similarity index or an average similarity index is used as a matching degree between the delivery person and the to-be-allocated order. For example, a similarity index between an existing order and the to-be-allocated order may be calculated according to an attribute of the existing order and an attribute of the to-be-allocated order, where the attribute may be, for example, a location attribute, a store attribute, and/or a related time attribute.

For example, the similarity index between an existing order and the to-be-allocated order may be analyzed according to location attributes, where a close distance between the existing order and the to-be-allocated order indicates a high similarity index.

For example, the similarity index between an existing order and the to-be-allocated order may be analyzed according to types of stores to which the existing order and the to-be-allocated order belong, where similar stores to which the existing order and the to-be-allocated order belong indicate a high similarity index between the existing order and the to-be-allocated order.

For example, the similarity index between an existing order and the to-be-allocated order may be analyzed according to ordering times, where the ordering time of the existing order is close to an ordering time of the to-be-allocated order indicate a high similarity index between the two.

The pre-allocated delivery person may be selected from the first delivery person set according to the obtained matching degree between each delivery person in the first delivery person set and the to-be-allocated order. For example, a delivery person may be selected as the pre-allocated delivery person, where a matching degree between the delivery person and the to-be-allocated order is the highest, or a delivery person may be selected as the pre-allocated delivery person, where a matching degree between the delivery person and the to-be-allocated order falls within a specified range.

In an application, each time a new order is received, the new order is used as a to-be-allocated order, and step 201 is performed to pre-allocate the new order to the pre-allocated delivery person.

In another application, the order allocation procedure may be periodically executed. Each time a period ends, new orders received in the period are obtained, the received new orders are used as to-be-allocated orders, and step 201 is performed to pre-allocate the new orders to respective pre-allocated delivery persons.

Regardless of which application is used, different orders may be pre-allocated to one delivery person, and a pre-allocated delivery person may have multiple orders.

Continue to refer to step 202: Group orders pre-allocated to the pre-allocated delivery person to obtain at least one order group, where the to-be-allocated order is grouped into an order group in the at least one order group.

Optionally, the orders pre-allocated to the pre-allocated delivery person may be grouped into the at least one order group randomly. In this optional implementation, different order groups may include different number of orders.

Optionally, the orders pre-allocated to the pre-allocated delivery person may be grouped into the at least one order group evenly. In this optional implementation, different order groups include the same number of orders.

Optionally, the orders pre-allocated to the pre-allocated delivery person may be grouped into the at least one order group according to a similarity index between the orders. The similarity index between the orders may be calculated according to attributes of the orders.

In step 202, the to-be-allocated order is grouped into an order group, to simulate a grouping allocation method. The order group to which the to-be-allocated order belongs is equivalent to a data object group to which a to-be-allocated data object belongs.

Continue to refer to step 203: Allocate a reference delivery person for the order group to which the to-be-allocated order belongs, where the reference delivery person is a delivery person different from the pre-allocated delivery person.

In a specific implementation, allocating the to-be-allocated order to the reference delivery person is actually sending the to-be-allocated order to a terminal of the reference delivery person. Therefore, the terminal of the reference delivery person is equivalent to the foregoing second terminal.

To simulate the grouping allocation method, in addition to grouping the to-be-allocated order into the order group, a delivery person needs to be allocated for the order group. For ease of differentiation, the delivery person allocated for the order group is referred to as a reference delivery person. Optionally, there may be multiple reference delivery persons.

Optionally, to improve the simulation effect and reduce impact on delivery persons to which orders are pre-allocated in the simulation process, the reference delivery person may be selected from delivery persons in the first delivery person set to which no order is pre-allocated.

For ease of description, the delivery persons to which no order is pre-allocated may be obtained from the first delivery person set to form a second delivery person set, where the second delivery person set includes at least one delivery person. The reference delivery person is selected, from the second delivery person set, for the order group to which the to-be-allocated order belongs.

Optionally, for any delivery person in the second delivery person set, the delivery person may have multiple orders, a matching degree between the delivery person and each order in the order group may be calculated according to the existing orders of the delivery person, and then a group matching degree between the delivery person and the order group is calculated according to the matching degree between the delivery person and each order in the order group.

Optionally, for any order in the order group, calculating a matching degree between the delivery person and the order may be: separately calculating similarities between existing orders of the delivery person and the order, and using the highest similarity index or an average similarity index as the matching degree between the delivery person and the order. For example, a similarity index between an existing order and the order may be calculated according to an attribute of the existing order and an attribute of the order, where the attribute may be, for example, a location attribute, a store attribute, and/or a related time attribute. Optionally, in the process of obtaining the group matching degree between the delivery person and the order group according to the matching degree between the delivery person and each order in the order group, a largest matching degree or an average matching degree may be selected as the group matching degree between the delivery person and the order group.

The reference delivery person may be selected from the second delivery person set according to the obtained group matching degree between each delivery person in the second delivery person set and the order group. For example, at least one reference delivery person may be selected, where a group matching degree between the reference delivery person and the order group is greater than a threshold; or at least one reference delivery person may be selected, where a group matching degree between the reference delivery person and the order group is the largest.

Continue to refer to step 204: Simulate processes of delivering the order group by the pre-allocated delivery person and the reference delivery person to obtain delivery indicator data of the pre-allocated delivery person and delivery indicator data of the reference delivery person.

The orders pre-allocated to the pre-allocated delivery person are grouped into at least one order group. Each order group Obtained by grouping pre-allocated orders may be allocated to the pre-allocated delivery person using the parallel allocation method for delivery, and may also be allocated to each reference delivery person in the at least one reference delivery person using the grouping allocation method for delivery. After the processes of delivering the order group by the pre-allocated delivery person and the reference delivery person are simulated, a final allocation method is selected according to simulation results.

In this embodiment, an example of simulating the processes of delivering, by the pre-allocated delivery person and the reference delivery person, the order group to which the to-be-allocated order belongs is used for description. For ease of description and brevity, the pre-allocated delivery person and the reference delivery person are both regarded as simulation objects. As shown in FIG. 3, the simulating the processes of delivering the order group to which the to-be-allocated order belongs includes:

2041. Form a list of to-be-delivered orders according to the order group to which the to-be-allocated order belongs and an undelivered order of a simulation object, where the simulation object is the pre-allocated delivery person or the reference delivery person for the to-be-allocated order.

2042. Design a delivery route of the simulation object according to a selected route designing algorithm according to attribute information of orders in the list of to-be-delivered orders.

2043. Estimate, according to an average speed and the delivery route of the simulation object, indicator data to be generated when the orders in the list of to-be-delivered orders are actually delivered, and use the indicator data as delivery indicator data of the simulation object.

Since the pre-allocated delivery person or the reference delivery person already have orders, while the to-be-allocated order needs to be quickly delivered, after the to-be-allocated order is allocated to the pre-allocated delivery person or the reference delivery person, we need to ensure that the to-be-allocated order imposes no significant or adverse impact on the existing orders of the pre-allocated delivery person or the reference delivery person. Therefore, the list of to-be-delivered orders may be generated with reference to the undelivered orders of the pre-allocated delivery person or the reference delivery person to comprehensively design a delivery route.

In this embodiment, the route designing algorithm may be selected in advance. For example, a shortest path algorithm, or an estimated arrival time algorithm can be selected, but it is not limited to such algorithms. The delivery route of the pre-allocated delivery person or the reference delivery person is designed according to the selected route designing algorithm according to the attribute information of the orders in the list of to-be-delivered orders.

According to the shortest path algorithm, a shortest route is designed according to locations of the orders in the list of to-be-delivered orders, and is used as the delivery route of the pre-allocated delivery person or the reference delivery person. Distance costs of this delivery route are the lowest.

According to the estimated arrival time algorithm, the delivery route of the pre-allocated delivery person or the reference delivery person is designed according to estimated arrival times of the orders in the list of to-be-delivered orders and based on a sequence of the estimated arrival times.

In addition, an average speed of the pre-allocated delivery person or the reference delivery person may be obtained. For example, statistics about a history delivery distance and used time of the pre-allocated delivery person or the reference delivery person may be collected according to history order data of the pre-allocated delivery person or the reference delivery person, and then the average speed of the pre-allocated delivery person or the reference delivery person is obtained according to the respective history delivery distance and used time. Alternatively, the average speed of the pre-allocated delivery person or the reference delivery person may be directly obtained from another system such as a speed simulation system.

The indicator data to be generated when the orders in the list of to-be-delivered orders are actually delivered is estimated based on the average speed and the delivery route of the pre-allocated delivery person or the reference delivery person, and is used as the delivery indicator data of the pre-allocated delivery person or the reference delivery person.

Optionally, there may be multiple reference delivery persons, and respective delivery indicator data of the multiple reference delivery persons may be obtained.

Continue to refer to step 205: Calculate an evaluation score of the pre-allocated delivery person or the reference delivery person according to the delivery indicator data of the pre-allocated delivery person or the reference delivery person.

Continue to refer to step 206: Determine whether the evaluation score of the pre-allocated delivery person is higher than the evaluation score of the reference delivery person; and if a determining result is yes, or the evaluation score of the pre-allocated delivery person is higher than the evaluation score of the reference delivery person, step 207 is performed; if a determining result is no, or the evaluation score of the pre-allocated delivery person is lower than or equal to the evaluation score of the reference delivery person, step 208 is performed.

207. Independently allocate the to-be-allocated order to the pre-allocated delivery person in a parallel allocation method.

208. The parallel allocation method fails, and the to-be-allocated order is re-allocated using the grouping allocation method.

In this embodiment, the delivery indicator data of the pre-allocated delivery person and the reference delivery person is not specifically limited. For example, the delivery indicator data may include at least one of the following: extra traveling distance, duration for completing the to-be-allocated order, duration for completing other orders in the list of to-be-delivered orders, number of delayed orders in the list of to-be-delivered orders, total delayed time period, average value, variance, or the like.

A shorter extra traveling distance indicates a better effect of the corresponding allocation method; a shorter duration for completing the to-be-allocated order indicates a better effect of the corresponding allocation method; a shorter duration for completing other orders indicates a better effect of the corresponding allocation method; a smaller number of delayed orders indicates a better effect of the corresponding allocation method; a shorter total delayed time period indicates a better effect of the corresponding allocation method; and so on.

Optionally, the delivery indicator data of the pre-allocated delivery person and the delivery indicator data of the reference delivery person may be directly compared, which allocation method is better is determined according to the comparison result, and then it is determined whether to use the parallel allocation method to independently allocate the to-be-allocated order to the pre-allocated delivery person.

In this embodiment, there are multiple pieces of delivery indicator data, and methods for comparing different pieces of delivery indicator data are different, so it is complex to directly comparing the delivery indicator data of the pre-allocated delivery person and the delivery indicator data of the reference delivery person. Therefore, the comparison may be performed in a quantitative method. The evaluation score of the pre-allocated delivery person or the reference delivery person is calculated according to the delivery indicator data of the pre-allocated delivery person or the reference delivery person, and the evaluation scores of the pre-allocated delivery person and the reference delivery person are compared. This comparing method is simpler and more intuitive.

For example, a mapping relationship between each piece of delivery indicator data and a weight may be established in advance, and weights corresponding to the various pieces of delivery indicator data are determined based on the mapping relationship. For example, a weight corresponding to each piece of delivery indicator data of the pre-allocated delivery person and that of the reference delivery person may be obtained, and the weights are added together or other value processing is performed on the weights to obtain respective evaluation scores.

Optionally, when there are multiple reference delivery persons, the evaluation score of the pre-allocated delivery person may be compared with an evaluation score of each of the multiple reference delivery persons; if the evaluation score of the pre-allocated delivery person is greater than the evaluation score of each of the multiple reference delivery persons, or if the evaluation score of the pre-allocated delivery person is greater than evaluation scores of a majority of the reference delivery persons, it may be determined that the parallel allocation method is used. The majority of the reference delivery persons may be determined according to a preset proportion, such as ⅓ or 80%.

In this embodiment, the to-be-allocated order is not directly allocated to a delivery person using the parallel allocation method; instead, the to-be-allocated order is pre-allocated using the parallel allocation method, to a delivery person, i.e., a pre-allocated delivery person; the to-be-allocated order is grouped into an order group, and a reference delivery person is selected for the order group to implement grouping allocation; the processes of delivering the order group by the pre-allocated delivery person and the reference delivery person are simulated, two simulation results are compared, and if the simulation result corresponding to the pre-allocated delivery person is better than that of the reference delivery person, it indicates that after the to-be-allocated order is allocated to the pre-allocated delivery person using the parallel allocation method, it can be ensured that the to-be-allocated order will be timely completed, and completion of the existing orders of the pre-allocated delivery person will not be greatly affected. Therefore, the to-be-allocated order can be allocated to the pre-allocated delivery person using the parallel allocation method to implement automatic order allocation, ensure allocation efficiency and overall delivery efficiency.

It should be noted that the steps in the method according to the foregoing embodiment may be executed by one device, or the method may be executed by different devices. For example, step 101 and step 103 may be executed by a device A. In another example, step 101 and step 102 may be executed by a device A, and step 103 may be executed by a device B.

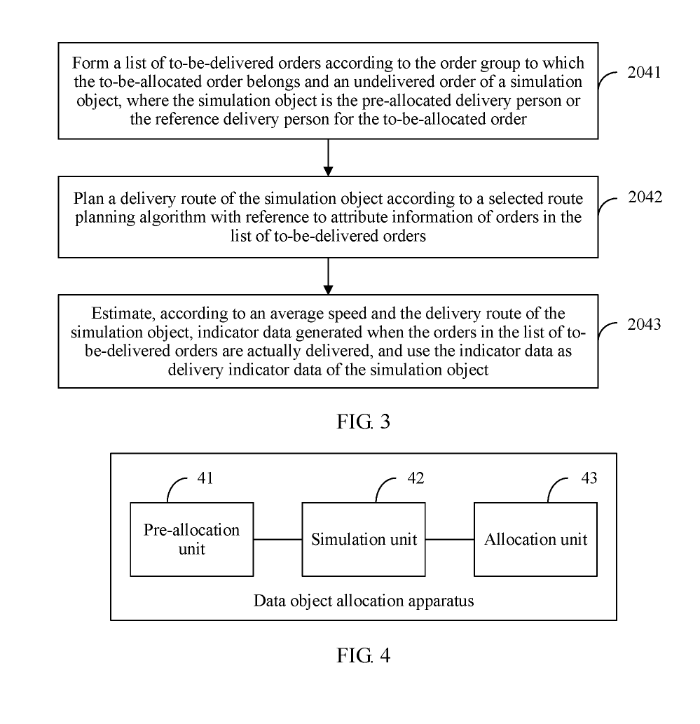

FIG. 4 is a schematic structural diagram of a data object allocation apparatus according to still another exemplary embodiment of the present invention. As shown in FIG. 4, the apparatus includes a pre-allocation unit 41, a simulation unit 42, and an al location unit 43.

The pre-allocation unit 41 is configured to pre-allocate a to-be-allocated data object to a first terminal, where the to-be-allocated data object is grouped into a data object group.

The simulation unit 42 is configured to simulate processing of the data object group by the first terminal and a second terminal associated with the data object group.

The allocation unit 43 is configured to allocate the to-be-allocated data object to the first terminal if two simulation results meet a preset condition.

In this embodiment, the data object allocation problem can be solved in a parallel allocation method. The parallel allocation method is a method of independently allocating a single data object to a terminal, and has relatively high allocation efficiency. In this embodiment, the parallel allocation method is used, but it is not directly used to perform data object allocation; instead, the parallel allocation method is compared with another allocation method using pre-allocation and simulation of the allocation effects to determine whether to use the parallel allocation method. In this embodiment, the another allocation method is mainly an allocation method of grouping data objects and allocating a data object to a terminal in a data object group method, but is not limited to such method

In an optional implementation, the pre-allocation unit 41 is configured to: determine a matching degree between each terminal in the first terminal group and the to-be-allocated data object; and select the first terminal from the first terminal group according to the matching degree between each terminal in the first terminal group and the to-be-allocated data object.

The first terminal in the first terminal group is used as an example for description, when determining a matching degree between the first terminal and the to-be-allocated data object, the pre-allocation unit 41 is configured to: calculate a similarity index between an existing data object of the first terminal and the to-be-allocated data object, and obtain a matching degree between the first terminal and the to-be-allocated data object according to the similarity index between the existing data object and the to-be-allocated data object. The method of allocating the existing data object is not limited. The existing data object may be allocated to the first terminal using the parallel allocation method, or may be allocated to the first terminal using the grouping allocation method.

Optionally, the similarity index between the existing data object of the first terminal and the to-be-allocated data object may be calculated according to an attribute of the existing data object and an attribute of the to-be-allocated data object. In an example, the existing data object and the to-be-allocated data object are orders, the attribute includes but is not limited to a store attribute, a user attribute, a time attribute, a location attribute, and the like that are related to the order.

In the foregoing implementation, the first terminal in the first terminal group is used as an example to describe the process in which the pre-allocation unit 41 determines a matching degree between a terminal and the to-be-allocated data object, and for a second terminal, a third terminal, and another terminal in the first terminal group, the same method may also be used to calculate a matching degree between the terminal and the to-be-allocated data object.

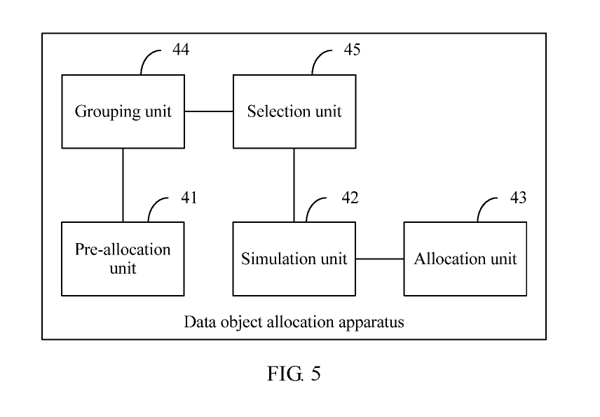

In an optional implementation, as shown in FIG. 5, the apparatus further includes a grouping unit 44, configured to group the to-be-allocated data object into a data object group.

Optionally, the grouping unit 44 is configured to: group data objects pre-allocated to the first terminal to obtain the data object group to which the to-be-allocated data object belongs. The pre-allocated data objects include the to-be-allocated data object.

Further, the grouping unit 44 is configured to: group the data objects pre-allocated to the first terminal according to a similarity index between the data objects pre-allocated to the first terminal to obtain the data object group to which the to-be-allocated data object belongs: Optionally, a similarity index between data objects may be calculated according to attributes of the data objects. For example, data objects that are close to each other may be grouped into a same data object group according to location attributes of the data objects; or data objects generated within a same time period may be grouped into a same data object group according to time attributes of the data objects.

In an optional implementation, as shown in FIG. 5, the apparatus further includes a selection unit 45, configured to select a second terminal associated with the data object group to which the to-be-allocated data object belongs.

Optionally, the selection unit 45 is configured to select the second terminal from a second terminal group, where the second terminal group includes at least one terminal to which no data object is pre-allocated.

Further, the selection unit 45 is configured to: determine a group matching degree between each terminal in the second terminal group and the data object group; and select the second terminal from the second terminal group according to the group matching degree between each terminal in the second terminal group and the data object group.

The second terminal in the second terminal group is used as an example. When determining the group matching degree between the second terminal and the data object group, the selection unit 45 is configured to: determine a matching degree between each data object in the data object group and the second terminal; and obtain a group matching degree between the data object group and the second terminal according to the matching degree between each data object in the data object group and the second terminal.

Further, a first data object in the data object group is used as an example. When analyzing a matching degree between the first data object and the second terminal, the selection unit 45 is configured to: determine a similarity index between an existing data object of the second terminal and the first data object, and calculate a matching degree between the first data object and the second terminal according to the similarity index between the existing data object of the second terminal and the first data object. Optionally, the similarity index between the existing data object and the first data object may be calculated according to an attribute of the existing data object and an attribute of the first data object.

In the foregoing implementation, the first data object is used as an example to describe the process of determining a matching degree between a data object and the second terminal, and for a second data object, a third data object, or another data object in the data object group, the same method may be used to calculate a matching degree between the data object and the second terminal.

In the foregoing implementation, the second terminal is used as an example to describe the process of determining a group matching degree between a terminal and the data object group, and for a first terminal, a third terminal, or another terminal in the second terminal group, the same method may be used to calculate a group matching degree between the terminal and the data object group.

Optionally, in an application, based on the first terminal group, the second terminal group may be derived from the first terminal group. For example, at least one terminal to which no data object is pre-allocated is obtained from the first terminal group to form the second terminal group.

In a logistics delivery application scenario, the to-be-allocated data object is a to-be-allocated order, the data object group to which the to-be-allocated data object belongs is an order group to which the to-be-allocated order belongs; correspondingly, the first terminal is a terminal of a pre-allocated delivery person corresponding to the to-be-allocated order, and the second terminal is a terminal of a reference delivery person selected for the order group; correspondingly, processing of the data object group by the first terminal and the second terminal is processes in which the pre-allocated delivery person and the reference delivery person deliver orders in the order group.

On the basis of the foregoing description, the simulation unit 42 is configured to: form a list of to-be-delivered orders according to the order group and an undelivered order of a simulation object, where the simulation object is the pre-allocated delivery person or the reference delivery person; design a delivery route of the simulation object according to a selected route designing algorithm according to attribute information of orders in the list of to-be-delivered orders; and estimate, according to an average speed and the delivery route of the simulation object, indicator data to be generated when the orders in the list of to-be-delivered orders are actually delivered, and use the indicator data as delivery indicator data of the simulation object.

On the basis of the foregoing description, the allocation 43 is configured to: calculate respective evaluation scores of the pre-allocated delivery person and the reference delivery person according to respective delivery indicator data of the pre-allocated delivery person and the reference delivery person; and if the evaluation score of the pre-allocated delivery person is higher than the evaluation score of the reference delivery person, allocate the to-be-allocated order to the pre-allocated delivery person.

The data object allocation apparatus according to this embodiment may be configured to execute the procedure of the foregoing method embodiment. Details are not described again.

According to the data object allocation apparatus in this embodiment, the parallel allocation method is used, but it is not directly used to perform data object allocation; instead, the parallel allocation method is compared with the grouping allocation method using pre-allocation and simulation of the allocation effects to determine whether to use the parallel allocation method; when the two simulation results meet the preset condition, the parallel allocation method is used, and the to-be-allocated data object is independently allocated to the first terminal. This not only ensures high allocation efficiency but also good overall processing effect.

In addition, the data object allocation apparatus provided in this embodiment may be applied to a logistics delivery application scenario. The apparatus determines, after pre-allocation, simulation, and comparing delivery effects of parallel allocation and grouping allocation, whether to use the parallel allocation method. If using the parallel allocation method can ensure that the to-be-allocated order is well completed, and completion of an existing order is not greatly affected, the to-be-allocated order is allocated to the pre-allocated delivery person using the parallel allocation method, so that allocation efficiency and overall delivery efficiency can be both optimized.

A person skilled in the art should understand that the embodiments of the present invention may be provided as a method, a system, or a computer program product. Therefore, the present invention may include hardware only embodiments, software only embodiments, or embodiments with a combination of software and hardware. Moreover, the present invention may include a computer program product that is implemented on one or more computer-usable storage media (including but not limited to a disk memory, a CD-ROM, an optical memory, and the like) storing computer-usable program code.

The present invention is described with reference to the flowcharts and/or block diagrams of the method, the device (system), and the computer program product according to the embodiments of the present invention. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may be stored in a computer readable memory that can instruct the computer or any other programmable data processing device to work in a specific method, so that the instructions stored in the computer readable memory generate an artifact that includes an instruction apparatus. The instruction apparatus implements a specific function in one or more processes in the flowcharts and/or in one or more blocks in the block diagrams.

These computer program instructions may be loaded onto a computer or another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

In a typical configuration, the computer device includes one or more processors (CPU), an input/output interface, a network interface, and a memory.

The memory may include a non-persistent memory, a random access memory (RAM), a non-volatile memory, and/or another form that are in a computer readable medium, for example, a read-only memory (ROM) or a flash RAM (flash RAM). The memory is an example of the computer readable medium.

The computer readable medium includes persistent, non-persistent, movable, and unmovable media that may implement information storage by using any method or technology. Information may be a computer readable instruction, a data structure, a program module, or other data. An example of a computer storage medium includes but is not limited to a phase change memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or other optical storage, a cassette magnetic tape, tape and disk storage or another magnetic storage device or any other non-transmission media that may be configured to store information that a computing device can access. According to the definition in this specification, the computer readable medium does not include transitory computer readable media (transitory media), such as a modulated data signal and a carrier.

It should be further noted that, the terms “include”, “comprise”, or their any other variant is intended to cover a non-exclusive inclusion, so that a process, a method, an article, or an apparatus that includes a list of elements not only includes those elements but also includes other elements that are not expressly listed, or further includes elements inherent to such process, method, article, or apparatus. An element preceded by “includes a . . . ” does not, without more constraints, preclude the existence of additional identical elements in the process, method, article, or apparatus that includes the element.

A person skilled in the art should understand that the embodiments of the present invention may be provided as a method, a system, or a computer program product. Therefore, the present invention may include hardware only embodiments, software only embodiments, or embodiments with a combination of software and hardware,

Moreover, the present invention may include a computer program product that is implemented on one or more computer-usable storage media (including but not limited to a disk memory, a CD-ROM, an optical memory, and the like) storing computer-usable program code.

An embodiment of the present invention further provides an electronic device, including a memory and a processor.

The memory is configured to store one or more computer instructions, where the one or more computer instructions are executed by the processor to implement:

pre-allocating a to-be-allocated data object to a first terminal, where the to-be-allocated data object is grouped into a data object group;

simulating processing of the data object group by the first terminal and a second terminal associated with the data object group; and

allocating the to-be-allocated data object to the first terminal if two simulation results meet a preset condition.

An embodiment of the present invention further provides a computer readable storage medium, storing a computer instruction, where the following steps are implemented when the computer instruction is executed by a processor:

pre-allocating a to-be-allocated data object to a first terminal, where the to-be-allocated data object is grouped into a data object group;

simulating processing of the data object group by the first terminal and a second terminal associated with the data object group; and

allocating the to-be-allocated data object to the first terminal if two simulation results meet a preset condition.

The foregoing descriptions are merely embodiments of the present invention, and are not used to limit the disclosure. For a person skilled in the art, the present invention may have various modifications and variations. Any modification, equivalent replacement, or improvement made without departing from the spirit and principle of the present invention shall fall within the scope of the claims of the present invention.

What is claimed is:

1. A method for allocating a data object, comprising:
pre-allocating a to-be-allocated data object to a first terminal;
grouping the to-be-allocated data object into a data object group and selecting a second terminal associated with the data object group;
simulating processing of the data object by the first terminal and the data object group by the second terminal; and
allocating the to-be-allocated data object to the first terminal if simulation results of the first terminal and the second terminal meet a preset condition.

2. The method according to claim 1, wherein pre-allocating the to-be-allocated data object to the first terminal comprises:
determining a matching degree between each terminal in a first terminal group and the to-be-allocated data object; and
selecting the first terminal from the first terminal group according to the matching degree between each terminal in the first terminal group and the to-be-allocated data object.

3. The method according to claim 2, wherein determining a matching degree between each terminal in a first terminal group and the to-be-allocated data object comprises:
calculating a similarity index between an existing data object of the first terminal and the to-be-allocated data object; and
obtaining a matching degree between the first terminal and the to-be-allocated data object according to the similarity index between the existing data object and the to-be-allocated data object.

4. The method according to claim 1, further comprising:
grouping data objects pre-allocated to the first terminal to obtain the data object group; wherein
the data objects pre-allocated to the first terminal comprise the to-be-allocated data object 5. The method according to claim 4, wherein grouping data objects pre-allocated to the first terminal comprises:
grouping the data objects pre-allocated to the first terminal according to a similarity index between the data objects pre-allocated to the first terminal to obtain the data object group.

6. The method according to claim 1, further comprising:
selecting the second terminal from a second terminal group, wherein the second terminal group comprises at least one terminal to which no data object is pre-allocated.

7. The method according to claim 6, wherein selecting the second terminal from a second terminal group comprises:
determining a group matching degree between each terminal in the second terminal group and the data object group; and
selecting the second terminal from the second terminal group according to the group matching degree between each terminal in the second terminal group and the data object group.

8. The method according to claim 7, wherein determining a group matching degree between each terminal in the second terminal group and the data object group comprises:
determining a matching degree between each data object in the data object group and the second terminal; and
obtaining the group matching degree according to the matching degree between each data object in the data object group and the second terminal.

9. The method according to any one of claims 1, wherein the to-be-allocated data object is a to-be-allocated order, the data object group is an order group, the processing is delivery, the first terminal is a terminal of a pre-allocated delivery person, and the second terminal is a terminal of a reference delivery person.

10. The method according to claim 9, wherein simulating processing of the data object by the first terminal and the second terminal comprises:
forming a list of to-be-delivered orders according to the order group and an undelivered order of a simulation object, wherein the simulation object is the pre-allocated delivery person or the reference delivery person;
designing a delivery route of the simulation object according to a selected route designing algorithm according to attribute information of orders in the list of to-be-delivered orders; and
estimating, according to an average speed and the delivery route of the simulation object, indicator data to be generated when the orders in the list of to-be-delivered orders are actually delivered, and using the indicator data as delivery indicator data of the simulation object.

11. The method according to claim 10, wherein allocating the to-be-allocated data object to the first terminal if simulation results of the first terminal and second terminal meet a preset condition comprises:
calculating respective evaluation scores of the pre-allocated delivery person and the reference delivery person according to respective delivery indicator data of the pre-allocated delivery person and the reference delivery person, and
if the evaluation score of the pre-allocated delivery person is higher than the evaluation score of the reference delivery person, allocating the to-be-allocated order to the pre-allocated delivery person.

12. A data object allocation apparatus, comprising:
a pre-allocation unit, configured to pre-allocate a to-be-allocated data object to a first terminal, group the to-be-allocated data object into a data object group and to select a second terminal associated with the data object group;
a simulation unit, configured to simulate processing of the data object by the first terminal and the data object group by the second terminal; and
an allocation unit, configured to allocate the to-be-allocated data object to the first terminal if simulation results of the first terminal and the second terminal meet a preset condition.

13. The apparatus according to claim 12, wherein the pre-allocation unit is configured to:
determine a matching degree between each terminal in a first terminal group and the to-be-allocated data object; and select the first terminal from the first terminal group according to the matching degree between each terminal in the first terminal group and the to-be-allocated data object.

14. The apparatus according to claim 12, further comprising:
a grouping unit, configured to group data objects pre-allocated to the first terminal to obtain the data object group, wherein the data objects pre-allocated to the first terminal comprise the to-be-allocated data object.

15. The apparatus according to claim 12 further comprising:
a selection unit, configured to select the second terminal from a second terminal group, wherein the second terminal group comprises at least one terminal to which no data object is pre-allocated.

16. The apparatus according to claim 15, wherein the selection unit is configured to:
determine a group matching degree between each terminal in the second terminal group and the data object group; and
select the second terminal from the second terminal group according to the group matching degree between each terminal in the second terminal group and the data object group.

17. The apparatus according to claim 12, wherein the to-be-allocated data object is a to-be-allocated order, the data object group is an order group, the processing is delivery, the first terminal is a terminal of a pre-allocated delivery person, and the second terminal is a terminal of a reference delivery person.

18. The apparatus according to claim 17, wherein the simulation unit is configured to:
form a list of to-be-delivered orders according to the order group and an undelivered order of a simulation object, wherein the simulation object is the pre-allocated delivery person or the reference delivery person;
design a delivery route of the simulation object according to a selected route designing algorithm in accordance to attribute information of orders in the list of to-be-delivered orders; and
estimate, according to an average speed and the delivery route of the simulation object, indicator data to be generated when the orders in the list of to-be-delivered orders are actually delivered, and use the indicator data as delivery indicator data of the simulation object.

19. The apparatus according to claim 18, wherein the allocation unit is configured to:
calculate respective evaluation scores of the pre-allocated delivery person and the reference delivery person according to respective delivery indicator data of the pre-allocated delivery person and the reference delivery person; and
if the evaluation score of the pre-allocated delivery person is higher than the evaluation score of the reference delivery person, allocate the to-be-allocated order to the pre-allocated delivery person.

20. A computer readable storage medium, storing a computer instruction, wherein the following steps are implemented when the computer instruction is executed by a processor:
pre-allocating a to-be-allocated data object to a first terminal;
grouping the to-be-allocated data object into a data object group and selecting a second terminal associated with the data object group;
simulating processing of the data object by the first terminal and the data object group by the second terminal; and
allocating the to-be-allocated data object to the first terminal if simulation results of the first terminal and the second terminal meet a preset condition.
